(19) United States
(12) Patent Application Publication
(10) Pub. No.: US 2013/0302222 A1
(43) Pub. Date: Nov. 14, 2013

(54) Synthetic Gas Generator

(71) Applicant: LINDE AG, Pullach (DE)

(72) Inventor: Juergen GLASER, Wolfratshausen (DE)

(73) Assignee: LINDE AG, Pullach (DE)

(21) Appl. No.: 13/889,496

(22) Filed: May 8, 2013

(30) Foreign Application Priority Data
May 8, 2012 (DE) 10 2012 009 150.8

(51) Int. Cl. B01J 19/00

(52) U.S. Cl. CPC B01J 19/0053
USPC 422/600

(57) ABSTRACT

The invention relates to an apparatus for generating synthetic gas, comprising a POX reactor with a first reaction chamber, into which a carbon-containing gaseous feedstock, as well as an oxidizing agent, can be introduced via a feeding system, and a discharge system, whereby a gasification product can be withdrawn from the reaction chamber. The apparatus further contains at least one further, i.e., a second, reaction chamber with a second feeding system, which is connected to the first reaction chamber via the discharge system.

### SUMMARY OF THE INVENTION

The invention relates to a device for generating synthetic gas, having a reactor (a partial oxidation reactor or POX reactor) with a first reaction chamber, into which a carbon-containing feedstock as well as an oxidizing agent can be introduced via a feeding system in order to be converted by partial oxidation into a crude synthetic gas that can be removed from the reaction chamber via a discharge system.

Such devices have been known to one skilled in the art for many years. They are used to gasify carbon and liquid hydrocarbons, but also to recover synthetic gas that contains hydrogen and carbon monoxide from gaseous feedstocks—in particular from natural gas. The reaction chamber of a POX reactor is usually limited by a refractory lining, which for its part is surrounded by heat insulation as well as a pressure-resistant steel jacket. It is essentially designed as a vertical cylinder on whose upper end a burner is arranged, which is used as a feeding system for the carbon-containing feedstocks and the oxidizing agent. At its lower end, the cross-section of the reaction chamber is tapered conically in order to ultimately empty into a pipe that is faced (lined) with refractory material and that forms a discharge system for the crude synthetic gas.

POX reactors are used in, for example, so-called GTL (gas-to-liquid) applications, whereby gaseous feedstocks (primarily natural gas) are converted into liquid hydrocarbons. The crude synthetic gas that is recovered in the reaction chamber by partial oxidation is typically fed at a pressure of approximately 35 bar via the discharge system to a crude gas condenser, where it is cooled off under the production of high-pressure vapor, i.e., the crude synthetic gas is cooled and partially condensed by heat exchange against a high-pressure process liquid, and the high pressure process liquid is vaporized producing a high-pressure vapor. In the subsequent process steps, a synthetic gas made up of predominantly hydrogen and carbon monoxide is recovered from the cooled crude synthetic gas. In particular, these subsequent process steps provide for the separation of water, carbon dioxide, and other undesirable substances. This synthetic gas is fed to a Fischer-Tropsch reactor, in which at a pressure of approximately 25 bar, long-chain hydrocarbons, which are present as liquid under environmental conditions, are synthesized.

For economic reasons, which are brought about primarily by the difficulties that increase with growing size in the construction project, the reaction chamber volume of a POX reactor is currently limited to approximately 50 m³. With such a reactor, under the conditions of a GTL application, at most a synthetic gas stream of approximately 250,000 mN³/h can be recovered, which in general is not sufficient to cover the synthetic gas requirement of a GTL unit. According to the state of the art, GTL units are therefore multiple-line, i.e., designed with several synthetic gas generators, which are operated in parallel. Each of these lines gives rise to high-level investment and operating costs and therefore has a negative effect on the economic efficiency of a GTL unit. By using larger POX reactors, the number of lines can admittedly be reduced, but the advantage gained would be more than offset by shipping problems because of the resulting high weight and the considerably greater complexity of the large-sized refractory facing (lining).

Therefore, one object of this invention is to provide an apparatus of the above-described type by which the drawbacks of the state of the art are overcome.

Upon further study of the specification and appended claims, other objects, aspects and advantages of the invention will become apparent.

These objects and aspects are achieved by providing a POX reactor having at least one second reaction chamber with a second feeding system, which is connected to the first reaction chamber via the discharge system.

According to the invention, each of the reaction chambers of the POX reactor can have any geometry. For example, a reaction chamber can be arranged symmetrically around a longitudinal axis, along which it has a circular, oval, or else rectangular cross-section. In a sensible manner, each of the reaction chambers, however, is essentially designed both in volume and in geometry like the reaction chamber of a POX reactor that is known from the state of the art, which has already proven its value in industrial use. The reaction chambers are thus essentially cylindrical, whereby the feeding system is arranged at one end of the cylinder, while a cone that empties into the discharge system is attached to the other end of the cylinder. In this case, the cylinder axis corresponds to the longitudinal axis of the reaction chamber. Preferably, the reaction chambers are designed with the same geometry and the same volume, so that each reaction chamber has an identical production capacity.

One configuration of the invention calls for the longitudinal axes of the reaction chambers to all cut through at least one point located behind the feeding systems in the direction of flow of the crude synthetic gas, whereby the longitudinal axes of all reaction chambers preferably lie in a plane. In other words, the longitudinal axes of the reaction chambers all have at least one point in common; they intersect at at least one point. In this case, deviations, such as result from the production tolerances that are common in the design of large units, are to be permissible.

A preferred configuration of the invention calls for the POX reactor to be designed with specifically two reaction chambers, whose longitudinal axes are at an angle to one another of between 60° and 180°. In this case, the longitudinal axes can encompass any angle to the perpendicular. Preferably, the longitudinal axes of the two reaction chambers, however, encompass the same angle to the perpendicular, with which they lie in a plane. For example, the axes of the reaction chambers lie in one plane with the vertical, with which they form the same angle. An especially preferred configuration of the invention calls for the two reaction chambers to have coincident, vertical, or horizontal longitudinal axes.

Suitably, the system according to the invention is equipped with at least one crude gas condenser, which is connected to the POX reactor in such a way that crude synthetic gas that is formed can be drawn off from the reaction chambers via the discharge system and can be fed to the crude gas condenser for cooling. Preferably, the number of crude gas condensers is equal to or less than the number of the reaction chambers of the POX reactor.

The discharge system is logically designed with a pressure-resistant steel jacket in which heat insulation as well as a refractory lining is arranged in such a way that channels are formed, via which synthetic gas is drawn off from the reaction chambers and can be fed to the crude gas condenser(s).

Preferably, the channels are designed as straight cylinders, but other shapes, which have, for example, rectangular cross-sections, are also conceivable.

The steel vessels that contain the reaction chambers as well as the discharge system can be transported to their site of use prefabricated to a large extent and, once there, joined together to the POX reactor at comparatively low cost. The invention therefore makes it possible to implement economically a POX reactor that has the capacity of multiple POX reactors from the state of the art, and nevertheless can easily be transported.

Below, the invention is to be explained in more detail based on an embodiment that is depicted diagrammatically in FIG. 1. In the figure, the same reference numbers refer to the same unit components.

### BRIEF DESCRIPTION OF THE DRAWINGS

The invention as well as additional details of the invention are explained in more detail below based on the embodiment shown in the drawing, wherein:

FIG. 1 illustrates an embodiment according to the invention.

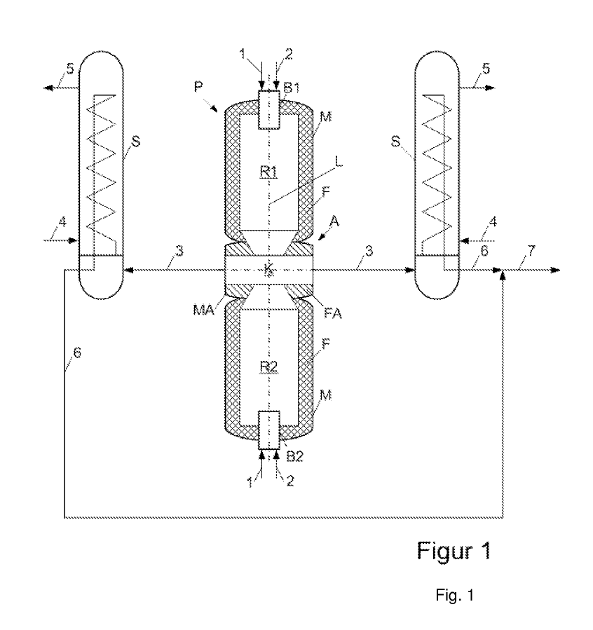

The embodiment of FIG. 1 shows a device according to the invention for generating synthetic gas with a POX reactor, which is designed with two vertical reaction chambers.

The POX reactor P has two reaction chambers R1 and R2, which are designed essentially identically and are arranged above one another so that their perpendicular longitudinal axes L coincide. The preferably cylindrical reaction chambers R1 and R2 are in each case limited by a facing F, formed from a refractory lining as well as heat insulation, which is surrounded by a pressure-resistant steel jacket M. At one end of each of the reaction chambers R1 and R2, a burner B1, B2 is arranged, which is used as a feeding system, via which an oxidizing agent 1, such as, for example, oxygen, as well as a carbon-containing feedstock 2, such as, for example, natural gas, can be introduced into reaction chambers R1 and R2, and converted there, at elevated pressure, in an exothermal reaction to form a crude synthetic gas. At their ends opposite the burners B1 and B2, the reaction chambers R1 and R2 are connected to one another by the discharge system A. The discharge system A, whose outside shell is also formed by a pressure-resistant steel jacket MA, is provided with a facing FA that is formed from heat insulation as well as a refractory lining. The discharge system forms an essentially cylindrical channel K that runs perpendicular to the longitudinal axes of the reaction chambers R1 and R2 and is open towards both sides. The reaction chambers R1 and R2 empty into the discharge system in such a way that the formed crude synthetic gas can be withdrawn via the lines 3 to the crude gas condensers S. In the crude gas condensers S, the hot crude synthetic gas can be cooled in indirect heat exchange with fresh water 4, whereby steam is generated, which can be drawn off via the lines 5. The two crude gas condensers S are connected via the lines 6 to the collecting line 7, via which the cooled crude synthetic gas can be fed to the subsequent purification and separation systems (not shown).

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German patent application DE 10 2012 009 150.8, filed May 8, 2012, are incorporated by reference herein.

1. An apparatus for generating synthetic gas, said apparatus comprising:
a reactor (POX reactor) (POX) comprising a first reaction chamber (R1), a first feeding system (B) by which a carbon-containing feedstock (2) and an oxidizing agent (1) can be introduced into said first reaction chamber (R1), and a discharge system (A) for withdrawing from said first reaction chamber (R1) a gasification product, which is a crude synthetic gas, formed by partial oxidation of the carbon-containing feedstock (2) in said first reaction chamber (R1),
wherein said POX reactor (POX) further comprises a second reaction chamber (R2) having a second feeding system (B2), which is connected to said first reaction chambers (R1) via said discharge system (A).

2. An apparatus according to claim 1, wherein each of said reaction chambers (R1, R2) is arranged symmetrically around a longitudinal axis (L).

3. An apparatus according to claim 2, wherein the longitudinal axes (L) of said reaction chambers (R1, R2) each cut through at least one point located behind the first and second feeding systems (B1, B2) in the direction of flow of crude synthetic gas.

4. An apparatus according to claim 2, wherein both longitudinal axes (L) of the reaction chambers (R1, R2) lie in a plane.

5. An apparatus according to claim 3, wherein both longitudinal axes (L) of the reaction chambers (R1, R2) lie in a plane.

6. An apparatus according to claim 2, wherein the longitudinal axes (L) of said first and second reaction chambers (R1, R2) are at an angle of between 60° and 180° to one another.

7. An apparatus according to claim 3, wherein the longitudinal axes (L) of said first and second reaction chambers (R1, R2) are at an angle of between 60° and 180° to one another.

8. An apparatus according to claim 4, wherein the longitudinal axes (L) of said first and second reaction chambers (R1, R2) are at an angle of between 60° and 180° to one another.

9. An apparatus according to claim 5, wherein the longitudinal axes (L) of said first and second reaction chambers (R1, R2) are at an angle of between 60° and 180° to one another.

10. An apparatus according to claim 6, wherein the longitudinal axes (L) of said first and second reaction chambers (R1, R2) lie in a plane with the perpendicular and encompass this same angle.

11. An apparatus according to claim 10, wherein the longitudinal axes (L) of said first and second reaction chambers (R1, R2) in each case run vertically or horizontally.
